(19) United States
(12) Patent Application Publication
(10) Pub. No.: US 2002/0025386 A1
(43) Pub. Date: Feb. 28, 2002

(54) Method and device for treating a surface of a component

(76) Inventors: Rolf Heinemann, Lehre (DE); Klaus Farber, Gifhorn (DE); Thomas Heider, Wolfsburg (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 09/933,052

(22) Filed: Aug. 20, 2001

Related U.S. Application Data
(63) Continuation of application No. PCT/EP00/00574, filed on Jan. 26, 2000.

(30) Foreign Application Priority Data
Feb. 19, 1999 (DE) 199 07 103.9
Sep. 1, 1999 (DE) 199 41 563.3

(51) Int. Cl. B05D 1/08

(52) U.S. Cl. 427/446; 427/596

(57) ABSTRACT

A method of treating a surface of a component includes performing a thermal spraying in a given treatment zone on a surface of a component. A laser surface treatment is performed in front of the given treatment zone, at the given treatment zone and/or behind the given treatment zone. The thermal spraying and the laser surface treatment are performed in a single processing step. A device for treating a component surface includes a plasma torch for providing a plasma jet and a laser for providing a laser beam. The plasma torch and the laser are configured to sweep the plasma jet and the laser beam over a component surface and to perform a surface treatment in a single pass.

### CROSS-REFERENCE TO RELATED APPLICATION

This application is a continuation of copending International Application No. PCT/EP00/00574, filed Jan. 26, 2000, which designated the United States.

### BACKGROUND OF THE INVENTION

### FIELD OF THE INVENTION

The invention relates to a method of treating a surface of a component in a treatment zone on the surface of the component. The invention also relates to a device for treating a surface of a component.

Sub-eutectic aluminum-silicon alloys are often used as a material for cylinder crankcases. However, such sub-eutectic aluminum-silicon alloys are unsuitable as far as the tribological demands on the piston/piston ring/cylinder bore system are concerned, since there is only an insufficiently large proportion of the wear-resistant silicon phase in such sub-eutectic aluminum-silicon alloys. Super-eutectic alloys, such as the alloy AlSi₇Cu₄Mg, have an adequate proportion of silicon crystallites. This hard, wear-resistant structural component is raised out of the matrix, which is formed of aluminum mixed crystals, by chemical and/or mechanical processing steps and forms a required carrier surface portion. However, these super-eutectic alloys also have disadvantages. When compared to sub-eutectic alloys, super-eutectic alloys have a relatively poor castability, a poor processibility and they are expensive.

One way to avoid some of these disadvantages is to cast cylinder liners in the cylinder bore. The cylinder liners are made of a wear-resistant material such as gray cast iron alloys and super-eutectic aluminum alloys. But this method is problematic with respect to forming a connection between the liner and the surrounding cast, because the connection is only ensured by a mechanical interlocking. When using a porous ceramic liner material, it is possible to infiltrate the liner material during the casting process and thus to obtain a material bond. This requires a slow filling of the casting mold and the application of high pressure, which substantially reduces the economic efficiency of the method.

Alternatively, sub-eutectic and near-eutectic alloys of galvanic coatings are applied directly onto the cylinder bores. But this is expensive and gives only an insufficient tribochemical resistance. Another alternative are thermal spray layers, which are also applied directly onto the cylinder bores, i.e. the cylinder bearing surfaces. However, the adhesion strength or peel strength of these layers is insufficient due to an exclusively micromechanical bracing or interlocking.

It has therefore already been suggested, for instance in Published, Non-Prosecuted German Patent Application No. DE 196 43 029 A1, to carry out surface modifications including remelting, introducing materials by alloying, dispersing, and coating with the aid of a laser. However, the disadvantage of this technique is that the cylinder bore coatings which are created in this way are too porous and have a relatively small depth of penetration. As a result, the adhesion of the applied layer is weaker than desired.

### SUMMARY OF THE INVENTION

It is accordingly an object of the invention to provide a method and a device for treating a surface of a component which overcome the above-mentioned disadvantages of the heretofore-known methods and devices of this general type and which provide a layer that has a low porosity and a strong adhesion and which achieve this layer within a short processing time.

With the foregoing and other objects in view there is provided, in accordance with the invention, a method of treating a surface of a component, the method includes the steps of:

performing a thermal spraying in a given treatment zone on a surface of a component such that the given treatment zone is moved in a given direction;

performing a laser surface treatment in at least one region selected from the group consisting of a region located in front of the given treatment zone as viewed in the given direction, a region located at the given treatment zone, and a region located behind the given treatment zone as viewed in the given direction; and

performing the thermal spraying and the laser surface treatment in a single processing step.

The method according to the invention provides that the surface of the component is treated in a single processing step, in other words in a single pass, by a thermal spraying and a laser surface treatment.

The method according to the invention advantageously provides a processing technique that has an increased penetration depth or infiltration depth, an improved introduction of the applied materials into the component and an improved bonding of the material which is applied by thermal spraying to the material of the component.

According to a further mode of the invention, the step of performing the laser surface treatment includes remelting a material at the surface of the component.

According to another mode of the invention, the thermal spraying includes a flame spraying, a plasma spraying, or a HV (high velocity) spraying.

Expediently, the laser surface treatment, in particular a remelting procedure, is carried out in front of the treatment zone, in the region of the treatment zone, and/or in back of the treatment zone in which the thermal spraying occurs. To further improve the properties or characteristics of the applied coating, the surface of the component is additionally treated, in particular remelted, with a laser beam subsequent to the preceding treatment.

The component may for example be an aluminum component, in particular a crankcase of a reciprocating internal-combustion engine at whose cylinder bearing surfaces the coating is performed. Therefore, according to another mode of the invention, a crankcase of a reciprocating internal-combustion engine is used as the component that is to be treated, and cylinder bearing surfaces of the crankcase are coated by performing the thermal spraying and the laser surface treatment. Here, according to a preferred mode of the invention, a cooling medium flows through a water space of the crankcase when the wear-resistant surface is produced. The cooling medium is in particular a gas such as nitrogen or a cooling fluid.

According to a particularly preferred mode of the invention, a powdery material, in particular silicon or a silicon alloy, is deposited on the material of the component through the use of the thermal spray jet in order to produce a wear-resistant surface. The material of the component is preferably aluminum.

Expediently, the material of the component in the treatment zone is melted into a molten pool or puddle during the laser surface treatment.

According to an advantageous mode of the invention, a wear-resistant surface in the form of a thermal spray layer is formed on the surface of the component when being treated in accordance with the surface treatment according to the invention.

In order to shorten the processing time, in areas of the component surface that are under less stress, i.e. in areas that are under less frictional load, only a partial surface treatment is performed. For this partial surface treatment, a thermal spray jet covers the surface of the component at least partly in a given pattern. In other words, the thermal spray jet sweeps in a given pattern over at least a portion of the surface of the component.

According to a preferred mode of the invention, the step of performing the thermal spraying includes sweeping a thermal spray jet in a given pattern over at least a portion of the surface of the component.

According to another mode of the invention, the step of performing the thermal spraying includes sweeping a thermal spray jet in a given pattern over at least a portion of the surface of the component such that the given pattern includes at least one substantially helical sweep of a given pitch. The angle of the pitch is preferably between 1° and 90°.

According to yet another mode of the invention, the step of performing the thermal spraying includes sweeping a thermal spray jet in a given pattern over at least a portion of the surface of the component such that the given pattern includes two substantially helical, oppositely directed sweeps of a given pitch.

As described above, the given pattern includes at least one sweep, and in particular two sweeps in opposite directions or more than two helical or spiral sweeps over the surface being processed, wherein the sweeps have a given pitch with an angle of between 1° and 90°. Alternatively or in addition, the pattern includes a linear sweep pattern, an angled sweep pattern, a cruciform sweep pattern, and/or a punctiform sweep pattern over the surface that is being processed.

According to a further mode of the invention, a cylinder bearing surface for a piston in a crankcase of a reciprocating internal-combustion engine is provided as the surface of the component, and the thermal spraying is performed by sweeping a thermal spray jet in a given pattern over at least a portion of the surface of the cylinder bearing surface in a region between a top dead center (TDC) and a bottom dead center (BDC) of a piston stroke.

According to yet another mode of the invention, the step of performing the thermal spraying includes sweeping a thermal spray jet over the surface of the component such that a partial region of the surface of the component is entirely covered by the sweeping of the thermal spray jet. For instance, highly stressed regions of the component are treated such that a thermal spray jet passes over a partial region of the component surface so that this partial region is entirely treated (full-area treatment) and this partial region is fully alloyed.

According to a further mode of the invention, a cylinder bearing surface for a piston in a crankcase of a reciprocating internal-combustion engine is provided as the surface of the component, and the thermal spraying is performed by sweeping a thermal spray jet at least over given regions of the cylinder bearing surface, the given regions including a region at a top dead center and/or a region at a bottom dead center of a piston stroke, and the given regions are entirely covered with the sweeping of the thermal spray jet. In other words, if the surface being treated is a cylinder bearing surface for a piston in a cylinder of a crankcase of an internal-combustion engine, then the treatment that covers the surface in the given regions completely is preferably carried out in a region of the top and/or bottom dead center of the piston stroke.

According to another mode of the invention, a cylinder bearing surface for a piston in a crankcase of a reciprocating internal-combustion engine is provided as the surface of the component to be treated, and the thermal spraying is performed by sweeping a thermal spray jet at least over given regions of the cylinder bearing surface, the given regions including a region at a top dead center and/or a region at a bottom dead center of a piston stroke, wherein the given regions are entirely covered with the sweeping of the thermal spray jet, and wherein the given regions have a respective height corresponding to at least a height of a piston ring package of the piston.

According to another mode of the invention, a cylinder bearing surface for a piston in a crankcase of a reciprocating internal-combustion engine is provided as the surface of the component to be treated, and the thermal spraying is performed by sweeping a thermal spray jet at least over given regions of the cylinder bearing surface, the given regions including a region at a top dead center and/or a region at a bottom dead center of a piston stroke, wherein the given regions are entirely covered with the sweeping of the thermal spray jet, and wherein the given regions have a respective height greater than a height of a piston ring package of the piston such that the given regions extend beyond the height of the piston ring package by 12% of a length of a piston stroke, for example by 5 mm. In other words, the surface treatment that entirely covers the given regions is carried out such that at least a given height that corresponds to a height of the piston ring packet of the piston is fully covered. As explained above, the surface treatment that entirely covers the given regions is preferably performed such that the surface treatment covers not only the height of the piston ring package, but extends beyond the height of the piston ring package by 12% of a piston stroke. The surface treatment may for instance extend approximately 5 mm beyond the height of the piston ring package.

It is particularly advantageous to perform a honing process subsequent to the coating process according to the invention so that the coated surface can be smoothed.

With the objects of the invention in view there is also provided, a device for treating a component surface, including:

a plasma torch for providing a plasma jet;

a laser for providing a laser beam; and

said plasma torch and said laser being operatively connected and configured to sweep the plasma jet and the laser beam over a component surface and to perform a surface treatment in a single pass.

In other words, a device according to the invention includes a plasma torch and a laser, which are disposed such that a beam of the laser and a plasma jet of the plasma torch sweep across the surface of the component in one process step (i.e. cycle of operation) for treating the surface.

An advantage of the method and device according to the invention is that a treatment is achieved that has an increased penetration depth or infiltration depth, an improved introduction of the applied materials into the component and an improved bonding of the material which is applied by thermal spraying to the material of the component.

According to a preferred embodiment of the device according to invention, the plasma torch and the laser are configured such that the surface of the component is first swept by the beam of the laser and then by the plasma jet of the plasma torch.

The treatment of the surface forms a wear-resistant surface on the component surface. The component includes in particular an Al—Si alloy and is for example a crankcase of a reciprocating internal-combustion engine, at whose cylinder bearing surfaces the surface treatment is performed.

Also, the component may be constructed of aluminum, and the plasma jet deposits silicon powder for the purpose of forming an Al—Si alloy as a wear-resistant surface of the component. In other words, according to another feature of the invention, the plasma torch is preferably configured to deposit, with the plasma jet, a silicon powder on a surface of an aluminum-containing component such that a wear-resistant surface including an AL—Si alloy is formed.

Other features which are considered as characteristic for the invention are set forth in the appended claims.

Although the invention is illustrated and described herein as embodied in a method and a device for treating a surface of a component, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic sectional view of a preferred embodiment of a device for treating a component surface according to the invention;

FIG. 2 is an enlarged, diagrammatic partial sectional view of a treatment zone on a surface of a component that is being treated for illustrating the method according to the invention;

FIG. 3 is a diagrammatic, partial sectional view of a component whose surface is treated in accordance with a first treatment pattern according to the invention;

FIG. 4 is a diagrammatic, partial sectional view of a component whose surface is treated in accordance with a second treatment pattern according to the invention; and

FIG. 5 is a diagrammatic, partial sectional view of a component for illustrating further treatment patterns according to the invention;

### DESCRIPTION OF THE PREFERRED EMBODIMENTS

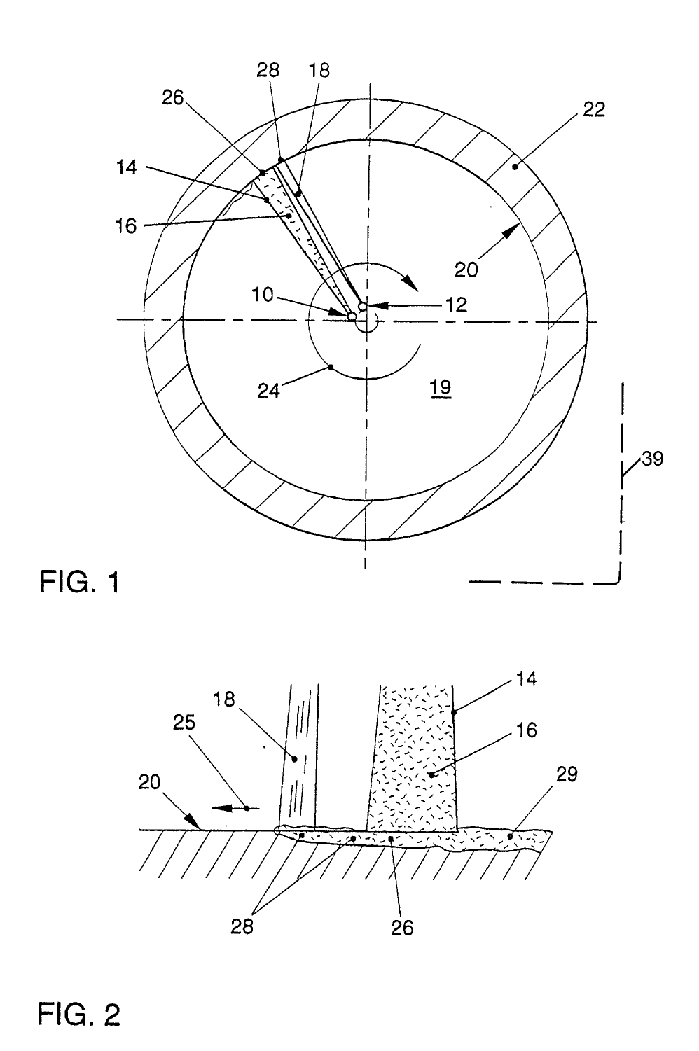

Referring now to the figures of the drawings in detail and first, particularly, to FIGS. 1 and 2 thereof, there is illustrated an embodiment of a device according to the invention which includes a plasma torch 10 and a laser 12. The plasma torch 10 emits a plasma jet 14 that contains a coating material 16. The laser 12 emits a beam 18. The component to be treated is a crankcase 39 of an internal combustion engine. The crankcase 39 is only schematically indicated with a dashed line. The crankcase 39 has cylinder bores or cylinders 19, wherein a surface 20 of a cylinder wall 22 is to be treated. The crankcase 39 is for example formed of aluminum, and the treatment of the surface 20 has the purpose of forming a wear-resistant surface in a region of the cylinder bearing surface on which a piston moves up and down in the cylinder 19. To accomplish this, the coating material 16 includes silicon powder, which is deposited on the surface 20 through the use of the plasma jet 14, wherein the silicon is deposited as a partly molten coating element. To accomplish this, the plasma jet 14 is swept over the surface 20 by guiding the plasma torch 10 into the cylinder 19 and turning the plasma torch 10 about its axis, as indicated by arrow 24 in FIG. 1 and arrow 25 in FIG. 2. The region in which the plasma jet 14 hits the surface at a given moment is referred to as the treatment zone or coating zone 26. In this region, the coating material 16 enters into the material of the cylinder wall 22.

The laser 12 that is provided in addition to the plasma torch 10 is provided such that it strikes the surface 20 in front of the plasma jet 14 as viewed in the direction of processing 25. The energy of the laser 12 is selected or adjusted such that the material of the cylinder wall 22 melts at the point where the laser beam 18 is incident and produces a melt or a molten pool 28 immediately prior to the impact, i.e. the incidence, of the plasma jet 14. In other words, the plasma jet 14 follows behind the laser beam 18 and delivers the coating material 16 that is contained in the plasma into the molten pool 28. In this way, the coating material 16 is optimally alloyed into the material of the cylinder wall 22. Alternatively, the method according to the invention can be performed such that the melting with the laser beam occurs subsequent to the deposition of the coating material 16 with the plasma jet 14.

According to the invention, a laser coating process is coupled with a plasma coating process and the entire coating process is executed in a single process step. The distance between the laser beam 18 and the plasma jet 14 is a function of the laser power, the desired melt depth, the melt length (length of molten pool), the degree of reflection (reflection coefficient) of the material of the cylinder wall 22, and the diameter of the cylinder 19, among other factors.

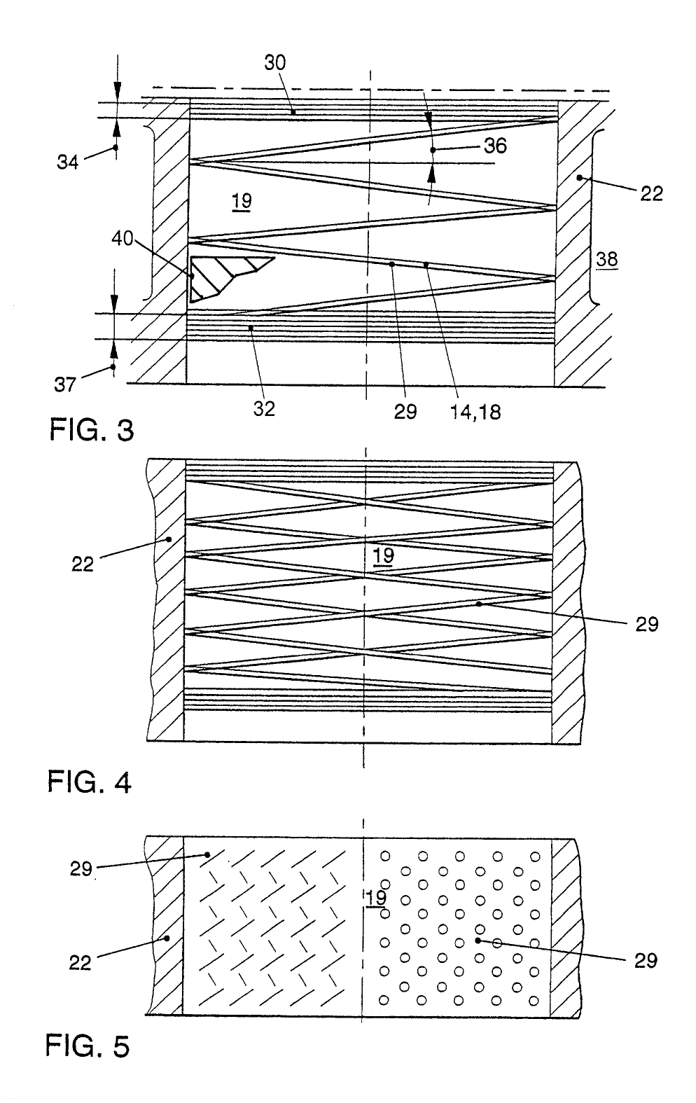

According to the invention, the double beam formed of the laser beam 18 and the plasma jet 14 is swept or passed over the surface 20 such that not the entire cylinder bearing surface is covered, but rather only a given region of the cylinder bearing surface is covered in accordance with a given pattern. FIGS. 3 to 5 show exemplary patterns for a laser alloying and deposition trace 29.

As can be seen in FIG. 3, a full-area coverage is provided in regions of the cylinder bearing surface that correspond to a top dead center 30 and a bottom dead center 32 of a piston stroke. The piston 40 is only partially shown at a position between the top dead center 30 and the bottom dead center 32. In particular, the full-area coverage is provided over a height 37 that corresponds to a height 34 of a piston ring package plus for example 5 mm, corresponding to 12% of the piston stroke height. In a region between the top dead center 30 and the bottom dead center 32, the laser beam 18 and the plasma jet 14 sweep over the surface 20 in a helical or spiral fashion wherein the angle 36 of the pitch is between 1° and 90°.

FIG. 4 illustrates a pattern according to which the laser beam 18 and the plasma jet 14 sweep over the surface 20 according to a helix pattern that includes two helices that run in opposite directions. According to another preferred mode of the invention, a helical pattern that includes three or more helices is provided. FIG. 5 illustrates further sweep patterns on the surface 20. Advantageous sweep patterns include line-shaped sweeps, angle-shaped sweeps, cross-wise sweeps or sweeps in the form of dots.

Sweeping only over part of the surface 20 in regions of the surface 20 that are under less stress, in particular under a reduced frictional load, guarantees a sufficiently wear-resistant cylinder bearing surface, and additionally results in reduced processing times during production and thus in corresponding lower costs.

According to one aspect of the invention, the laser 12 is used to increase a silicon content 16 in a margin layer of a sub-eutectic or near-eutectic aluminum alloy of the cylinder wall 22. To accomplish this increase in silicon content in the one-step method represented here, AlSi powder is added into the melt 28 during the lasering process with the aid of a suitable feed. Depending on the load and wear demands that are to be achieved, layer thicknesses of over 2 mm can be realized. In this case only a small degree of mixing with the base material is desired. The silicon content in the supplied powder is in the range between 20% and 40%. If substantially smaller layer thicknesses with a high degree of mixing are required, powders 16 with a silicon content of between 40% and 60% are used. Since the powder particles 16 should completely dissolve in the melt 28, it is necessary to guarantee a minimal lifetime of the molten pool by appropriately selecting the process parameters related to the rate of advance and the laser power. For a cost-effective treatment, a suitable beam intensity distribution is preferred. Furthermore, melting lenses having an optimally rectangular cross-section and thus a small trace overlap are advantageous.

The alloying of the overall cylinder bearing surface may be a full-area alloying if necessary, but primarily a partial treatment is provided. The regions of the top and bottom reversal points (top piston dead center 30 and bottom piston dead center 32), which must stand up to an increased load, undergo a full-area remelting. However, only individual laser traces (e.g. rhombus pattern, cf. FIGS. 3 to 5) are applied to intermediate regions between the top dead center and the bottom dead center, that must stand up to a relatively smaller load, so that a sufficient wear protection is guaranteed there. This technique shortens the processing times substantially, since only a small part of the cylinder bearing surface or bore surface needs to be treated. If a laser surface treatment of the entire cylinder bearing surface or of the majority thereof is required, it is necessary to cool the cylinder housing. This is accomplished by conducting a cooling medium through a water space 38 of the existing cooling water system of the crankcase. In case only a partial surface treatment is performed, it is sufficient to dissipate the energy, which has been introduced by the surface treatment, with water-cooled copper plates that contact the top side and the bottom side of the component that is treated.

In summary, a combination of thermal spraying (plasma spraying) and laser surface treatment is proposed. This way, a porosity is reduced by remelting a previously applied spray layer, and, given sufficiently large melt-in depths, a connection to the base metal is achieved. Expediently, a full-area remelting with the laser 12 is only carried out in the regions that are highly loaded (e.g. frictional load), whereas the remaining regions are not subjected to any remelting or only to a remelting in accordance with a pattern, for instance a pattern with rhombuses, hatchings or spots.

According to the invention it is not only possible to simply perform a subsequent remelting of an applied spray layer. The molten pool 28 which is generated by the laser 12 directly in front of the plasma coating zone 26, as seen in the forward direction 25, results in a metallic bonding of the powder particles 16, which hit the substrate in a solid or liquid state. When there is a high rate of advance, the layer structure is formed of the substrate material, a thin alloyed zone with the dissolved and in some cases merely partially melted erstwhile powder particles 16, and a comparatively thick spray layer. Given correspondingly selected method parameters, the layer adhesion between the spray layer and the alloy layer can be substantially increased with the aid of this intermediate layer, due to an improved micro-interlocking. This saves an expensive and cost-intensive preparation (e.g. cleaning and blasting) of the surface 20 that must be coated, which would otherwise be necessary in order to achieve a sufficient adhesion of a spray layer. In order to smooth the coated surface, the coating method according to the invention can be followed by honing procedures, whose steps allow achieving various surface qualities.

The above described preferred embodiment is merely an example for explaining the invention. An essential aspect of the invention is the combination of a thermal spraying and a laser surface treatment in one step. The use of the laser beam and of the thermal spray may occur for example simultaneously; i.e., the laser beam 18 and the particle jet 14 which is generated by the thermal spraying method, for instance a plasma spraying, strike the same point. Alternatively, the laser beam and the thermal spray are applied consecutively; i.e., a thermal spray layer is first applied over all or part of the surface and is then remelted or alloyed into the surface with the laser beam 18 over all or part of the surface. The thermal spray merely deposits the coating material on the surface, thus producing only a mechanical interlocking between the surface of the component and the applied material. However the additional subsequent laser treatment melts the surface of the component immediately after the depositing process, so that also an alloying takes place.

We claim:

1. A method of treating a surface of a component, the method which comprises:
performing a thermal spraying in a given treatment zone on a surface of a component such that the given treatment zone is moved in a given direction;
performing a laser surface treatment in at least one region selected from the group consisting of a region located in front of the given treatment zone as viewed in the given direction, a region located at the given treatment zone, and a region located behind the given treatment zone as viewed in the given direction; and
performing the thermal spraying and the laser surface treatment in a single processing step.

2. The method according to claim 1, wherein the step of performing the laser surface treatment includes remelting a material at the surface of the component.

3. The method according to claim 1, wherein the step of performing the thermal spraying is carried out by performing a spraying process selected from the group consisting of a flame spraying, a plasma spraying, and a HV spraying.

4. The method according to claim 1, which comprises:
using a crankcase of a reciprocating internal-combustion engine as the component; and
coating cylinder bearing surfaces of the crankcase by performing the thermal spraying and the laser surface treatment.

5. The method according to claim 4, which comprises passing a cooling medium through a water space of the crankcase while performing the thermal spraying and the laser surface treatment.

6. The method according to claim 5, which comprises using, as the cooling medium, a medium selected from the group consisting of a gas and a liquid.

7. The method according to claim 5, which comprises using nitrogen as the cooling medium.

8. The method according to claim 1, which comprises:
performing the thermal spraying with a thermal spray jet; and
depositing, with the thermal spray jet, a powder material on the component.

9. The method according to claim 1, which comprises:
performing the thermal spraying with a thermal spray jet; and
depositing, with the thermal spray jet, a powder material selected from the group consisting of a silicon powder and a silicon alloy powder on the component.

10. The method according to claim 1, which comprises melting, with the laser surface treatment, a material of the component for providing a molten pool in a coating zone of the component.

11. The method according to claim 1, which comprises providing, as the component, an aluminum-containing component.

12. The method according to claim 1, which comprises forming a wear-resistant surface by treating the surface of the component with the thermal spraying and the laser surface treatment.

13. The method according to claim 1, which comprises forming a wear-resistant surface by forming a thermal spray layer on the surface of the component with the thermal spraying and the laser surface treatment.

14. The method according to claim 1, wherein the step of performing the thermal spraying includes sweeping a thermal spray jet in a given pattern over at least a portion of the surface of the component.

15. The method according to claim 1, wherein the step of performing the thermal spraying includes sweeping a thermal spray jet in a given pattern over at least a portion of the surface of the component such that the given pattern includes at least one substantially helical sweep of a given pitch.

16. The method according to claim 1, wherein the step of performing the thermal spraying includes sweeping a thermal spray jet in a given pattern over at least a portion of the surface of the component such that the given pattern includes two substantially helical, oppositely directed sweeps of a given pitch.

17. The method according to claim 1, wherein the step of performing the thermal spraying includes sweeping a thermal spray jet in a given pattern over at least a portion of the surface of the component such that the given pattern includes at least one substantially helical sweep having a pitch angle between 1° and 90°.

18. The method according to claim 1, which comprises:
providing a cylinder bearing surface for a piston in a crankcase of a reciprocating internal-combustion engine as the surface of the component; and
performing the thermal spraying by sweeping a thermal spray jet in a given pattern over at least a portion of the cylinder bearing surface in a region between a top dead center and a bottom dead center of a piston stroke.

19. The method according to claim 1, wherein the step of performing the thermal spraying includes sweeping a thermal spray jet in a given pattern over at least a portion of the surface of the component, the given pattern including at least one sweep pattern selected from the group consisting of a linear sweep, an angled sweep, a cruciform sweep and a punctiform sweep.

20. The method according to claim 1, wherein the step of performing the thermal spraying includes sweeping a thermal spray jet over the surface of the component such that a partial region of the surface of the component is entirely covered by the sweeping of the thermal spray jet.

21. The method according to claim 1, which comprises:
providing a cylinder bearing surface in a crankcase of a reciprocating internal-combustion engine as the surface of the component; and
performing the thermal spraying by sweeping a thermal spray jet at least over given regions of the cylinder bearing surface, the given regions including at least one region selected from the group consisting of a region at a top dead center and a region at a bottom dead center of a piston stroke, and entirely covering the given regions with the sweeping of the thermal spray jet.

22. The method according to claim 1, which comprises:
providing a cylinder bearing surface in a crankcase of a reciprocating internal-combustion engine as the surface of the component; and
performing the thermal spraying by sweeping a thermal spray jet at least over given regions of the cylinder bearing surface, the given regions including at least one region selected from the group consisting of a region at a top dead center and a region at a bottom dead center of a piston stroke, and entirely covering the given regions with the sweeping of the thermal spray jet, the given regions having a respective height corresponding to at least a height of a piston ring package of the piston.

23. The method according to claim 1, which comprises:
providing a cylinder bearing surface in a crankcase of a reciprocating internal-combustion engine as the surface of the component; and
performing the thermal spraying by sweeping a thermal spray jet at least over given regions of the cylinder bearing surface, the given regions including at least one region selected from the group consisting of a region at a top dead center and a region at a bottom dead center of a piston stroke, and entirely covering the given regions with the sweeping of the thermal spray jet, the given regions having a respective height greater than a height of a piston ring package of the piston such that the given regions extend beyond the height of the piston ring package by 12% of a length of a piston stroke.

24. The method according to claim 1, which comprises:
providing a cylinder bearing surface in a crankcase of a reciprocating internal-combustion engine as the surface of the component; and
performing the thermal spraying by sweeping a thermal spray jet at least over given regions of the cylinder bearing surface, the given regions including at least one region selected from the group consisting of a region at a top dead center and a region at a bottom dead center of a piston stroke, and entirely covering the given regions with the sweeping of the thermal spray jet, the given regions having a respective height greater than a height of a piston ring package of the piston such that the given regions extend 5 millimeters beyond the height of the piston ring package.

25. The method according to claim 1, which comprises honing the surface of the component subsequent to being coated by the thermal spraying and the laser surface treatment.

26. A device for treating a component surface, comprising:
a plasma torch for providing a plasma jet;
a laser for providing a laser beam; and
said plasma torch and said laser being operatively connected and configured to sweep the plasma jet and the laser beam over a component surface and to perform a surface treatment in a single pass.

27. The device according to claim 26, wherein said laser is configured to first sweep the laser beam over the component surface and said plasma torch is configured to subsequently sweep the plasma jet over the component surface.

28. The device according to claim 26, wherein said plasma torch and said laser are configured such that the laser beam and the plasma jet produce a wear-resistant surface on the component surface.

29. The device according to claim 26, wherein said plasma torch is configured to deposit, with the plasma jet, a silicon powder on a surface of an aluminum-containing component such that a wear-resistant surface including an AL—Si alloy is formed.

30. The device according to claim 26, wherein said plasma torch and said laser are configured to perform the surface treatment on a cylinder bearing surface in a crankcase of a reciprocating internal-combustion engine.
